(19) United States
(12) Patent Application Publication
(10) Pub. No.: US 2008/0018730 A1
(43) Pub. Date: Jan. 24, 2008

(54) For-hire vehicle interactive communication systems and methods thereof

(76) Inventor: Marc Roth, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/490,863

(22) Filed: Jul. 20, 2006

(51) Int. Cl. H04N 7/14; H04J 1/02

(52) U.S. Cl. 348/14.02; 370/493

(57) ABSTRACT

An interactive for-hire vehicle communication system and method of communicating selectable passenger-related information to a for-hire vehicle are disclosed. The system comprises an audio device located in a for-hire vehicle. A workstation is in communication with the audio devices and the workstation is also in communication with one or more passenger interfaces located in the for-hire vehicle. Either the workstation and/or servers are configured to receive passenger audio information received by the audio device. The passenger audio information is converted to text suitable for passenger-related interactive information exchange to one or more passenger interfaces of the for-hire vehicle. The system also may include a video device configured to receive image information suitable for transmission to one or more servers to provide interactive information exchange to passenger interfaces of the for-hire vehicle.

### FIELD OF THE INVENTION

The invention relates to for-hire vehicles and more particularly to improved for-hire vehicle interactive communication systems and methods configured to provide both security and added revenue streams to a vehicle operator.

### RELATED ART

Some current intelligent transportation systems use automated dispatch and metering to manage for-hire vehicle activities. In such systems on-board and centralized computers, telecommunications devices, global positioning systems (GPS) and the Internet may be used in combination or in single applications to assist in monitoring the location, condition, and performance of for-hire vehicles. In some cases, such systems may include tailored software applications for both for-hire vehicle drivers and managers of transportation systems.

With respect to state of the art automated dispatch systems, a selection process may assign drivers to a pick-up destination based upon the known location of available for-hire vehicles which are part of the system. Additionally, prioritized criteria, such as determining driver's responsiveness may be input into the dispatch system as part of the selection process. Driver's responsiveness may depend on personal factors associated with driver's personal situation, so such input may be inaccurate. Most dispatch systems combine some type of global positioning system (GPS) to locate an available mobile unit, help determine routing, and in some cases, provide pertinent real-time information such as current traffic conditions.

Additionally, voice communication may be used to convey for-hire assignments to one or more drivers. Once completed, for-hire assignment transactions may be paid for in various ways including but not limited to cash, credit, debit, and pre-paid vouchers. Typically, drivers of for-hire vehicles are at risk because of the handling of currency. Therefore, in some jurisdictions, video monitoring of the interior of for-hire vehicles is being considered or has been mandated. However, such security features are not typically included with both dispatching and advertising in any current transportation system.

Lately, several personalized advertising systems have come to market. Such systems have been designed to combine visual and computer technology to create mobile “broadcast style” media within for-hire vehicles. Passengers of for-hire vehicles may become captive viewers of advertisers' messages. Typically, such systems use a screen embedded in the back of the front seat of a for-hire vehicle, with the possibility of passenger interaction with the embedded screen. Passengers are able to follow route directions along with a driver, and participating local businesses may benefit from prime advertising space advertisements appear on the screen as the for-hire vehicle may pass a business's location. Additionally, passengers may be able to pay for the transportation services by swiping a credit card or other suitable monetary instrument. Such systems are standalone systems. A standalone system operates by itself and independently from any other services employed in the operation of a rental vehicle, such as one of the dispatch systems described above.

Integrated systems where more than one system is linked and optionally shares knowledge such as passenger details and the like are known. Such integrated systems combine, for example, video display techniques with dispatch techniques which allows for personalizing passenger specific messages during a journey in the for-hire vehicle. Such an integrated dispatch system may provide information regarding a passenger's destination together with a video display system showing targeted advertisements and information related to the passenger's routed destination.

In the above-described integrated dispatch and advertising systems, advertisers typically contract with an advertising agency. The advertising agency then interfaces with the dispatcher, which then interfaces with the dispatcher's for-hire vehicle operators. Since not all dispatchers in a community have an integrated dispatch and advertising systems, potentially many passengers are not targeted. Besides, one of the most important elements of successful advertising is entirely missed by the above-described systems, namely the personal interface between the driver and passengers.

When advertising agencies work through dispatcher companies, all potential advertisers are not likely to use passengers' captivity while in for-hire vehicles. Potential advertisers may find targeted advertising through advertising agencies based on the above dispatch/advertising system model to be too expensive. Additionally, advertisers do not receive feedback on the success of their advertising as substantiated by immediate passenger purchases from targeted messages.

In many cosmopolitan cities, many passengers may be non-local and non-native speaking. Such passengers may be confused by on-screen technology which may request that passengers choose their language. Therefore, advertisers are limited in their capability to properly target advertisements to passengers because the information supplied to advertisers for targeting may not be accurate. Advertisers may completely forego any chance of converting advertising opportunities to sales in this scenario.

The system, method and apparatus described below overcome these drawbacks and provide additional benefits.

### SUMMARY

In an embodiment of the invention, an interactive for-hire vehicle communication system is disclosed. The system comprises, in combination, one or more audio devices located in a for-hire vehicle. A workstation is in communication with one or more audio devices and the workstation is also in communication with one or more passenger interfaces located in the for-hire vehicle. Either the workstation and/or one or more servers in communication with the workstation are configured to receive passenger audio information received by the audio device. The workstation or the servers' configuration converts the passenger audio information to text suitable for passenger-related interactive information exchange to one or more passenger interfaces of the for-hire vehicle. The system also may include one or more video devices in communication with the workstation. The video devices are configured to receive image information suitable for transmission to one or more servers to provide interactive information exchange to passenger interfaces of the for-hire vehicle. A driver interface is coupled to the workstation and the driver interface is configured to input passenger data to the workstation. The passenger data is transmitted to one or more servers.

In another embodiment of the invention, a method of communicating selectable passenger-related information to a for-hire vehicle is disclosed. In any order of the following steps, at least one of audio information and video information is received by a workstation located in a for-hire vehicle. Furthermore, at least one of audio information and video information is transmitted to one or more servers in communication with the workstation. At least a portion of the audio information is converted to text by at least one of the workstation and the servers. Passenger-related input is generated at a driver interface coupled to the workstation. The passenger-related input is received by at least one of the workstation and the servers and selectable passenger-related information based on at least one of the text, the video information and the driver generated passenger-related input is communicated interactively with one or more passenger interfaces of the for-hire vehicle. The audio information and/or image information may be accessed from the workstation and/or one or more servers if requested during an emergency situation in the for-hire vehicle.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a schematic flow diagram of a for-hire vehicle communication system.

FIG. 2 illustrates a block diagram of a portion of apparatus of the system of FIG. 1.

FIG. 3 illustrates a security embodiment of the system of FIG. 1.

FIGS. 4A, B and C illustrate an operational flow diagram of an exemplary embodiment of a method for implementing the system of FIG. 1.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

While the features of a communication system may include automated dispatch and/or advertising systems, this system is not intended to be restricted to an automated dispatch and/or advertising system, but equally applies to any type of system used in any for-hire vehicle. The communication system may be configured so that there is greater interface between a driver of a for-hire vehicle and passengers of the for-hire vehicle. Furthermore, a driver may receive an incentive from transport system operators or advertisers for encouraging use of the communication system by passengers. The communication system may also ease the record-keeping activities burden of a driver and may provide better local information to drivers regarding passenger pick-up opportunities. Additionally, the communication system may provide greater security for drivers' safety and for passengers' goods deliberately or inadvertently left in the for-hire vehicle.

### 1. For-hire Vehicle Communication System

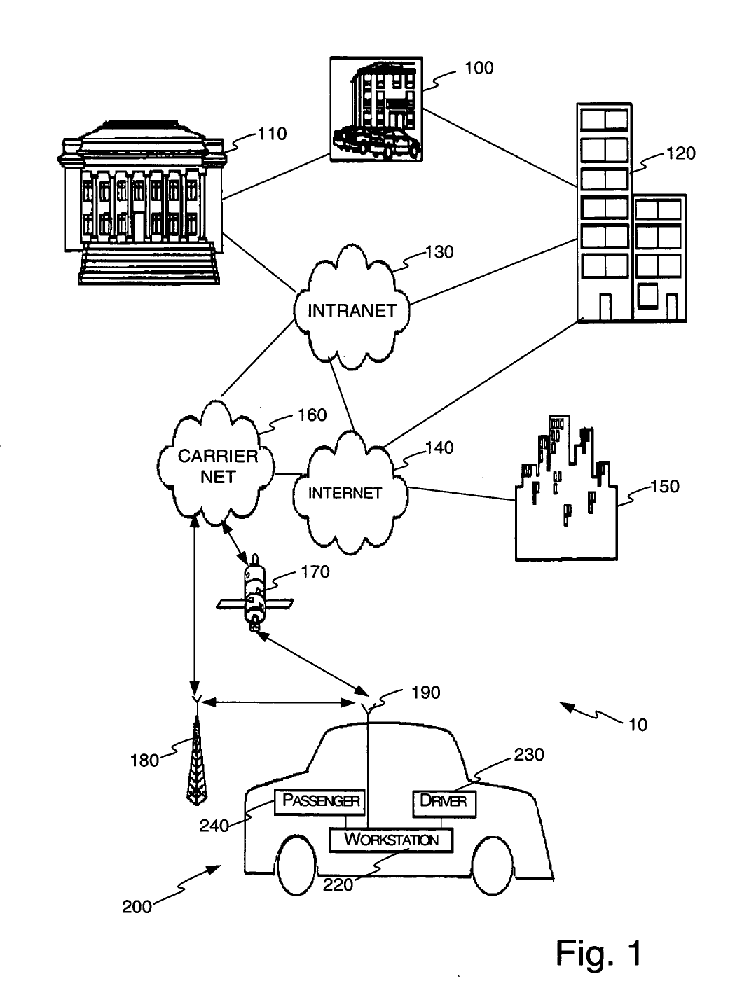

FIG. 1 illustrates an exemplary embodiment of a schematic diagram of a for-hire vehicle communication system 10. According to FIG. 1, a transportation system operator 100 (hereinafter denoted operator 100 or one or more operators 100) may communicate with one or more security agencies 110. Security agencies 110 may be private or public (such as local law enforcement). Furthermore, the operator 100 may communicate with one or more advertisers 120 or advertising agencies representing one or more advertisers. As used in this disclosure hereinafter, the term “advertisers” may denote one or more direct advertisers, one or more advertising agencies, one or more marketing agencies and the like or combinations thereof.

Without limiting the present disclosure, communication between operator 100 and security agencies 110, as well as between operator 100 and advertisers 120 may be by way of one or more hard-wired or wireless computer networks comprising one or more servers, one or more computer workstations, one or more routers and the like. Without limiting the scope of this disclosure, communication between operator 100, security agencies 110 and operator 100 and advertisers 120 may use any communication medium such as cable, DSL, telephone, cellular connections and the like.

In an exemplary embodiment of the communication system, an intranet 130 may provide secure communication between one or more operators 100 and one or more security agencies 110, and between one or more operators 100 and advertisers 120. The term “intranet” means a network of computers using standardized computer protocols or conventions that may be accessed only by an authorized set of users, as for example, those users within a single company, group of companies or agencies. The intranet 130 may be a secure hub such as a local area network (LAN) interfacing with a main server administered by operator 100. The term LAN means a group of computers configured to communicate with one another. Optionally a third party may provide a LAN which re-directs information between operator 100 and security agencies 110, as well as between operator 100 and advertisers 120. In an embodiment of the communication system, it is contemplated that communication between operator 100 and security agencies 110 may be separate from communications between operator 100 and advertisers 120.

Operator 100 may receive revenues from advertisers 120. Such revenues may comprise sign-up fees to connect to the operator's LAN and on-going fees for providing advertisements to passengers of for-hire vehicles.

It will be appreciated that operator 100 may be more than one transportation system operator and all such operators may be connected to intranet 130. Advantageously, in such an arrangement, advertisers may be able to advertise with a greater number of such operators and provide both offers for products and services to a greater number of passengers.

In another embodiment of the communication system, advertisers 120 wishing to target passengers of for-hire vehicles may directly advertise by providing a web site over the Internet 140. Optionally, advertisers may contract with other Internet advertising suppliers, such as GOOGLE™, YAHOO® and the like. Additionally, it will be appreciated that other information sources 150 wishing to target passengers of for-hire vehicles may also advertise directly through the Internet 140. Such information sources 150 may comprise weather, lodging, entertainment, local events, tours and the like. In this scenario, transportation system operators 100 may be deprived of revenue that would otherwise have been available to them. However, advertising and information which bypasses such operators 100 may not be as targeted to passenger needs (see description below).

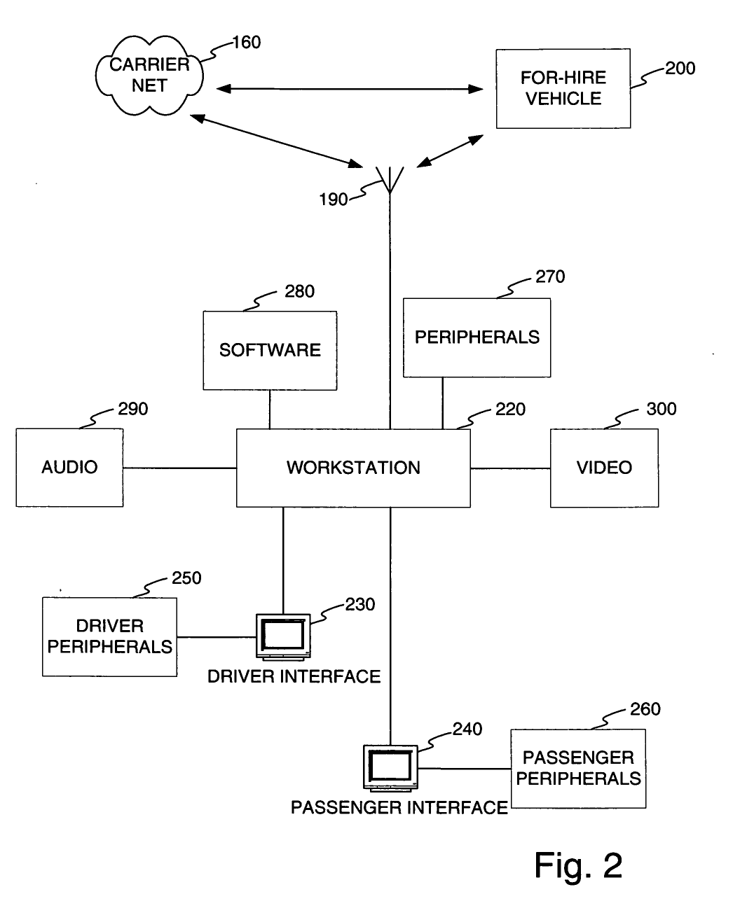

Advertising supplied by advertisers 120 and information sources 150 to the Internet 140 may be further disseminated to one or more carrier networks 160 (shown as Carrier Net in FIG. 1). Carrier networks 160 may be any network supplied by one or more utility carriers configured to communicate with Internet 140. Furthermore, intranet 130 may also communicate to carrier networks 160 rather than to Internet 140 and thence to carrier networks. Carrier networks 160 comprise one or more satellites 170, towers 180 and the like alone or in combination (see also FIG. 2). Carrier networks may further comprise antennas, routers, software (not shown) and the like responsive to communication from Internet 140 (and optionally intranet 130) to provide secured wireless capabilities.

Referring further to FIG. 1, one or more for-hire vehicles 200 may be configured to receive wireless communication from carrier net 160. In an exemplary embodiment, a for-hire vehicle 200 comprises one or more communication exchange devices 190 configured to receive transmission from carrier net 160. Communication exchange device 190 may comprise an antenna, a router, a global positioning system (GPS) or navigational device, radio, cell phone and the like, and combinations thereof. It is understood that such communication received from carrier net 160 may comprise any information (see description above) from Internet 140 and intranet 130 and also may include co-ordinate data from a GPS.

In one embodiment, the carrier net 160 may include transmitters at locations of an advertiser 120 or information source 150. For example, a particular advertiser 120 may comprise a restaurant. That restaurant may transmit information via a transmitter of the carrier net 160 to passing vehicles (such as those which travel a street in front of or adjacent to the restaurant).

Furthermore, drivers of for-hire vehicles 200 may communicate both with transportation system operators 100 and with other drivers of for-hire vehicles to provide local data regarding traffic activity and possible passenger pick up opportunities (see also FIG. 2). Such communication between drivers may be through carrier net 160 or by using other wireless devices such as mobile radio, cell phone and the like. It is contemplated that such direct communication between drivers may provide enhanced responsiveness to passenger needs while at the same time keeping transportation system operators aware of changing local traffic conditions when communication occurs through carrier net 160. Furthermore, such communications may provide an extra layer of security for drivers.

### 2. Apparatus of a For-hire Vehicle Communication System

FIG. 2 is a block diagram illustrating greater detail of a portion of apparatus of a for-hire vehicle communication system. Referring to both FIGS. 1 and 2, a for-hire vehicle comprises a workstation 220. The workstation 220 may comprise a computer system located in a portion of the for-hire vehicle 200. Without limitation, the workstation 220 may comprise a circuit board (not shown) having one or more central processing units (not shown) such as found in a laptop computer, a desktop computer, a personal digital assistant (PDA) and the like. It is contemplated that the workstation 220 is configured to be sufficiently small to be conveniently placed in any portion of the for-hire vehicle 200. The workstation 220 may be powered by a battery of the for-hire vehicle 200 (not shown) or any other power supply whether dependent or independent of the for-hire vehicle (not shown) and/or any combination thereof as is well understood by a person skilled in the art. Furthermore, the workstation's one or more central processing units have sufficient computing capability to perform numerous computing operations (see description below).

The workstation 220 further comprises a driver interface 230 and one or more passenger interfaces 240. The driver interface 230 may further comprise one or more driver peripherals 250. Driver peripherals 250 may comprise a display, output devices such as a printer and speakers, input devices such as a keyboard, a mouse, a stylus, a microphone, input/output ports and the like as is well known in the art (all not shown in detail in FIG. 2). In one embodiment the driver interface 230 may comprise a notebook style computer, tablet computer and the like communicating with the workstation 220. The driver interface 230 may be located in any portion of the for-hire vehicle 200 suitable for access by the driver.

In operation a driver may use the driver interface 230 to input passenger data such as where the passenger was picked up, where the passenger was delivered, where the passenger's luggage was delivered, suitable details regarding passengers, such as home address, purpose of the visit to where the passenger is traveling, range of passenger's probable age and the like. The driver interface 230 may also be coupled to a distance meter (shown as driver peripherals 250 in FIG. 2) indicating distance traveled and fare charged, as well as amounts received from the passenger in payment for services rendered to the passenger during the trip. Of course, the mileage meter may be directly coupled to the workstation 220. Such information may be used as a basis for providing extra income to the driver. The driver interface 230 may be used to input passenger data for processing by the workstation 220 and from the workstation to one or more servers of intranet 130. Optionally, of course, the driver interface 230 may be configured to directly communicate with the one or more servers directly. A further advantage of the driver interface 230 is that the driver no longer needs to keep written records which may be easily misplaced. Furthermore, data input by the driver into the driver interface 230 may be organized readily by accounting software located in either workstation 220 or at one or more operator designated servers. Drivers may be credited for their data input, and other activities such as passenger payments may be communicated to the driver interface 230.

Referring to FIG. 2, passenger interfaces 240 may receive targeted information resulting from a driver's use of driver interface 230. Passenger interfaces 240 may further comprise one or more passenger peripherals 260. Passenger peripherals 260 may comprise a display, output devices such as a printer, input devices such as a keyboard, a mouse, a stylus, a currency equivalents device, a speaker, input/output ports and the like, as is well known in the art (all not shown in detail in FIG. 2). A currency equivalence device may be a credit card or debit card swipe, a currency accepting receptacle, an identification device such as a RFID (radio frequency identification device) reader and the like or combinations thereof. Such a currency equivalents device is configured to facilitate efficient transactions between passengers and advertisers 120, as well as between passengers and drivers. For example, a passenger may pay for a transaction with a credit or a debit card, cash, traveler's check or any device having preprogrammed currency data such as a RFID token.

Furthermore, it is contemplated that the currency equivalents device may also provide for input of passenger identification information. The passenger identification information may provide yet another layer of security for drivers and passengers when this information is communicated to transportation system operators 100.

In a preferred embodiment, passenger interfaces 240 may be located in any portion of a for-hire vehicle 200 suitable for access by any passengers. Optionally, passenger interfaces may comprise a passenger's personal device, such as a notebook computer, tablet computer, cell phone, personal digital assistant and the like configured to communicate with the workstation 220. It will be appreciated that when a passenger's personal device is used, the workstation may be configured to communicate with the passenger's personal device (see description below). Such communication may occur through a wired or a wireless connection as is well understood by a person skilled in the art.

Referring again to FIG. 2, the workstation 220 may further comprise peripherals 270 configured to provide input to the workstation. Such peripherals 270 may include input/output ports, read/write devices such as hard drives, digital video and compact disc readers and writers, flash memory devices and the like as is understood by a person skilled in the art. The workstation may also comprise in-built memory adapted to retain data even when the workstation is not powered-on. Additionally, the workstation 220 may comprise software 280 preprogrammed into the workstation's memory. Such software 280 may comprise an operating system configured specifically for the workstation 220 or any other suitable operating system. Software 280 may comprise data downloaded from compact and digital video discs, flash memory devices and the like or combinations thereof. Data may comprise advertising pre-supplied by advertisers 120 for continuous play to passengers in for hire-vehicles 200. Furthermore, software 280 may comprise one or more audio and/or video conversion programs to facilitate capture of passengers' conversations and images.

When passengers speak with drivers or other passengers, these conversations may provide data suitable for targeted advertising. Furthermore, if a non-native language is spoken, such non-native language may be translated to both facilitate communication between drivers and passengers and to optionally provide a data base for targeted advertising directed to passengers. Imaging may also provide data suitable for targeted advertising and also provide yet another layer of security within a for-hire vehicle 200. For instance, if a passenger is attired in a business suit, advertisements may be targeted towards business activities, whilst if a passenger is informally attired advertisements may be targeted towards leisure activities. Other characteristics may be determined from such data, such as estimated age or gender of the passenger. Of course, a system for providing advertising and other information content to passengers in for-hire vehicles may be configured to account for the most likely passenger profiles associated with a specific location.

The workstation 220 preferably further comprises audio devices 290 (shown as AUDIO in FIG. 2) and video devices 300 (shown as VIDEO in FIG. 2). Audio devices 290 may comprise audio cards having input/output ports configured with one or more speakers and microphones as is understood be a person skilled in the art (not shown in detail in FIG. 2). Of course both audio devices 290 and video devices 300 may be hard-wired or wirelessly coupled to the workstation 220. In an embodiment of audio devices 290, when passengers speak with drivers or other passengers, the audio devices are configured to facilitate capture of conversations. Such conversations may provide data suitable for targeted advertising. Software may be suitably configured to also convert such conversations into text for facile transmission to one or more advertisers. Such software includes voice recognition software and may further include modified versions of voice recognition software designed to facilitate more accurate recognition of passenger and driver speech patterns. It is contemplated that voice recognition software and hardware may be configured to filter selected audio information. Such selected audio information may comprise background traffic noise and background music, since a for-hire vehicle environment can be noisy. Additionally, voice recognition software and hardware may be configured to amplify a selected portion of the audio information such as driver speech and passenger speech to further improve accuracy.

Furthermore, if a non-native language is spoken such non-native language may be translated by software 280 of the workstation 220 to both facilitate communication between drivers and passengers (either directly or via the displays) and to optionally provide a data base for targeted advertising. In an alternative embodiment, conversations may be communicated to intranet 130 and from there to a server having software configured to translate and/or convert the conversations into text. Such a server may provide sufficient computing power to prevent overload of workstation 220 during a translation and text conversion process. Advertisers 120 communicating with intranet 130 may then provide targeted advertisements to passengers by downloading to either intranet 130 or to Internet 140 in the passengers' language.

Video 300 may also act as a security feature for both passengers and a driver of a for-hire vehicle. Video 300 may be any kind of imaging and/or recording device to capture video images as understood by persons skilled in the art. Such imaging devices and recording devices include web cameras, video recorders and the like, and combinations thereof.

In an embodiment of imaging as a security feature, when video 300 is configured to provide real-time images of transactions within the for-hire vehicle, such transactions may be communicated to other for hire-vehicle drivers or to operator 100. Should there be an emergency situation in the for-hire vehicle, other for-hire vehicle drivers or operator 100 may communicate with security agencies 110 to initiate an alert. In another embodiment of imaging as a security feature, passengers may request playback of events occurring in a for-hire vehicle to determine if they may have inadvertently left any of their belongings in the for-hire vehicle.

In another embodiment of a security feature, a for-hire vehicle 200 may be in communication with a GPS system through communication exchange device 190 coupled to workstation 220. The GPS system may provide co-ordinates showing the location of the for-hire vehicle. If audio and/or video output from the workstation indicates an emergency situation, security agencies 110 may more rapidly respond to the emergency situation. In one embodiment, in such a situation, an emergency signal may be received directly by close proximity emergency personnel for response (such as a police car in close proximity), rather than having to be routed to dispatch and then having the emergency vehicle located via dispatch. This may significantly reduce response time of such personnel.

According to FIG. 2, workstation 220 is further coupled to communication exchange device 190. Communication exchange device 190 may be configured to communicate with carrier net 160 (see FIG. 1 and description above). Additionally, communication exchange device 190 may be configured to communicate with any other for-hire vehicle 200. Of course, communication exchange device 190 may also communicate with Internet 140 and/or an intranet 130 (see above). For example, as detailed above, an advertiser or other information source might be configured to communicate via a transmitter of the carrier net 160 to passing vehicles.

Other information may be provided to or transmitted from the vehicle. For example, location based advertising messages might be distributed from the vehicle 200 via the communication exchange device 190. This enables the vehicles 200 to be “mobile” transmitters. Emitted information might be received by pedestrians or other parties in the vicinity of the vehicle 200, such as by use of an appropriate information display device. Such a device might comprise a cell-phone or PDA (for example, the vehicle 200 might be used to broadcast information in Bluetooth or similar format which is recognizable by such personal devices).

In yet another aspect, the vehicle 200 might disseminate location information to advertisers or information sources which are in close proximity. For example, a vehicle 200 might broadcast its GPS/location information to a restaurant which is close by. That information might be accompanied with other information, such as the number or names of passengers. The information might be used by the restaurant to hold seating for the passengers.

Referring to FIG. 2 (and see also FIG. 1 and description above), since passengers may use passenger interface 240 to communicate directly through workstation 220 to carrier net 160, they may access any authorized information available through the carrier net. Authorized information may include Internet transmissions and advertising transmitted through intranet 130. It is contemplated that software 280 of workstation 220 may be configured to filter unauthorized communications from intranet 130. It will be appreciated that when passengers communicate via passenger interface directly to carrier net 160 numerous possibilities exist for targeted advertising.

In an embodiment of a method for targeting advertising to passengers, a passenger may be charged a fee for accessing passenger interface 240. An advantage of charging such a fee is that the fee may provide a profit center for operator 100. Optionally, advertisers 120 may pay a fee when they contract with operators 100 and part of the fee structure may permit passengers to freely access passenger interface 240. The fee for accessing passenger interface 240 may be charged to advertisers when a passenger accesses the advertiser's Internet and/or intranet site. Of course, any operator may select payers of any fees.

Initially, a passenger may simply desire to surf the Web for information and may need a convenient hook-up to the Web. The “Web” refers to accessing the World Wide Web through the Internet. A passenger may be offered a targeted product or service as previously described from information accumulated by video 300 and/or audio 290 in the for-hire vehicle. Video and/or audio may be further configured to permit the passenger to speak with a person associated with the offered product and/or service. For example, the passenger may wish to reserve a table at a restaurant or buy clothing to be delivered to a hotel where the passenger is staying. If so, the passenger may request the reservation. The fee for accessing passenger interface 240 may be waived if the passenger makes the reservation as determined by software 280 of workstation 220 or any other suitable method as is understood by persons skilled in the art. Similarly, if the passenger pays for the clothing by using a credit card, the fee may also be waived. Optionally, if the passenger pays for the clothing by accessing a currency equivalence device (not shown in detail) of passenger peripheral 260, the fee may be waived. After paying for a service or a product to be received by the passenger, a print out of the transaction may be retrieved by the passenger from a printer (not shown in detail) of passenger peripheral 260.

A driver of the for-hire vehicle 200 may earn further income by encouraging a passenger to use passenger interface 240 to view targeted advertisement sites. When the passenger purchases a product and/or service at a targeted advertisement site, the driver may be awarded a commission based on the purchase. Furthermore, while making purchases in the for-hire vehicle, a passenger may direct the driver to a location to pick-up a passenger's purchased product or have the product delivered to any location designated by the passenger. It will be appreciated that the combination of passenger interface 240 coupled to passenger peripherals 260 in the for-hire vehicle is advantageous to a passenger because the passenger has mobility while shopping.

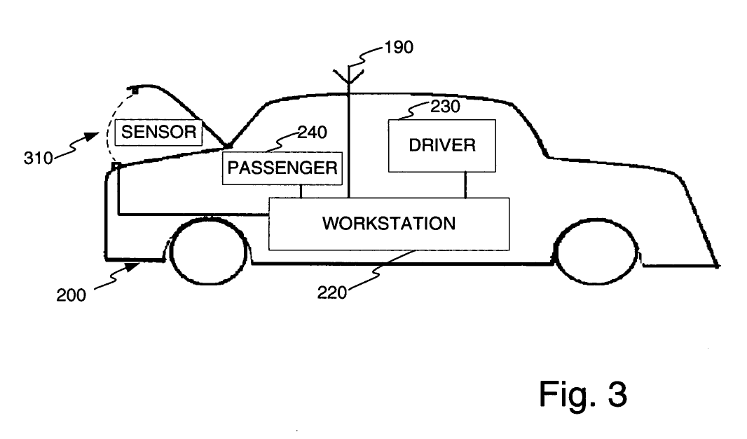

FIG. 3 illustrates a security embodiment of a for-hire vehicle communication system 10. According to FIG. 3, one or more sensors 310 may be located in a portion of the for-hire vehicle 200. Sensors 310 communicate with workstation 220 to monitor (and secure) a portion of the for-hire vehicle. Sensors 310 may be any type of sensor such as an optical, electrical contact, pressure and the like, and combinations thereof as is understood by persons skilled in the art.

According to an embodiment of sensors 310 as illustrated in FIG. 3, a sensor is located in a portion of a trunk of the for-hire vehicle 200. Of course, sensors 310 may be located in any portion of the for-hire vehicle 200 configured to receive passenger belongings. Passenger goods or belongings (such as luggage, purchases made during the trip) may be placed in the trunk and delivered to the passenger's selected destination. When the trunk is closed, workstation 220 receives a signal from sensor 310 indicating the trunk has been closed. The passenger may enter a security code that provides access to a date and time when the passenger's goods were placed in the trunk and the trunk was closed. The date/time and security code may be written to workstation memory (see FIG. 2 and description above).

During the trip, the passenger may request later delivery of the passenger's goods to a new destination (such as the passenger's hotel) which is different to an original passenger requested destination. The passenger may pre-pay a delivery charge for the requested delivery using a passenger peripheral configured to receive payments from the passenger (see FIG. 2 and discussion above). Furthermore, the passenger may receive a printed receipt showing the date, time and payment information (the passenger may pay up front or, if the cost is unknown, the passenger may be billed later for the delivery fees).

On reaching the passenger's destination and departure of the passenger from the for-hire vehicle, the driver may deliver the passenger's goods to the new destination. When the trunk is opened, a signal may be transmitted to workstation 220 and a time/date of opening the trunk and driver's identification may be recorded in workstation memory. The passenger's goods may be off-loaded at the new destination to a third party responsible for receiving the passenger's goods.

In this way a chain of responsibility for the passenger's goods may be reliably traced. For example, if the passenger wants to know whether the passenger's goods have been delivered, the passenger may contact operator 100 (see FIG. 1 and description above), supply the security code and receive feed-back regarding status of the delivery after the operator accesses the workstation of the for-hire vehicle. It will be appreciated that both passengers and drivers benefit from this security arrangement, because of the traceability features of sensors and workstations in the for-hire vehicles. Furthermore, sensors may be used in other portions of the for-hire vehicle to determine when a passenger enters the vehicle and also when the passenger departs the vehicle. These sensors may also activate passenger interfaces of workstations to begin monitoring passengers with video and audio (see FIG. 2 and description above).

### 3. Exemplary Implementation of a For-hire Vehicle Communication System

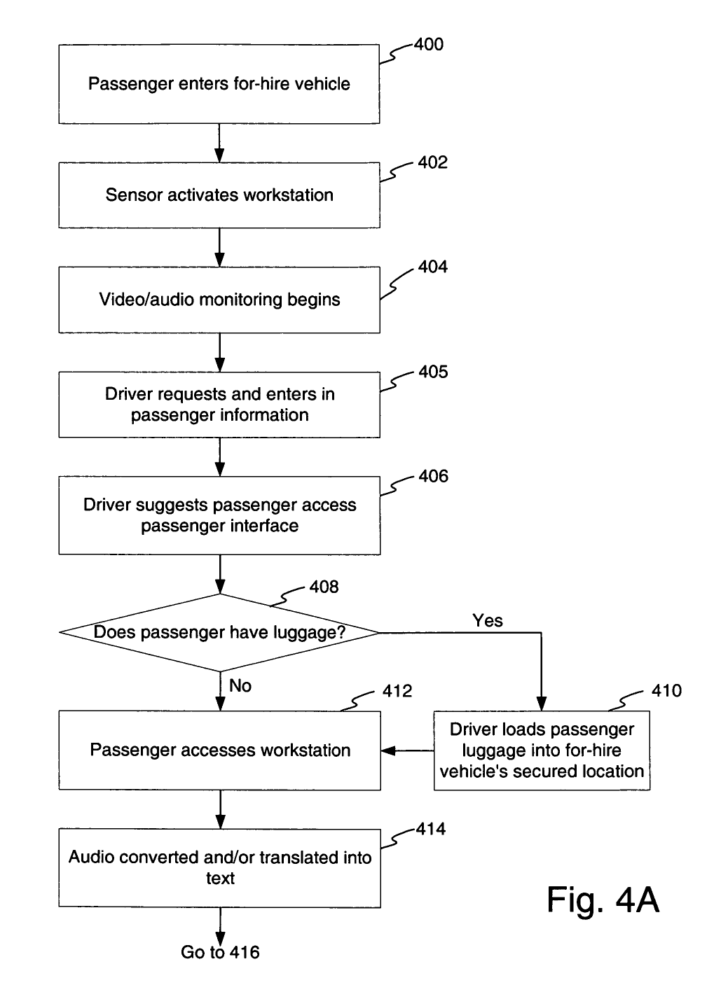

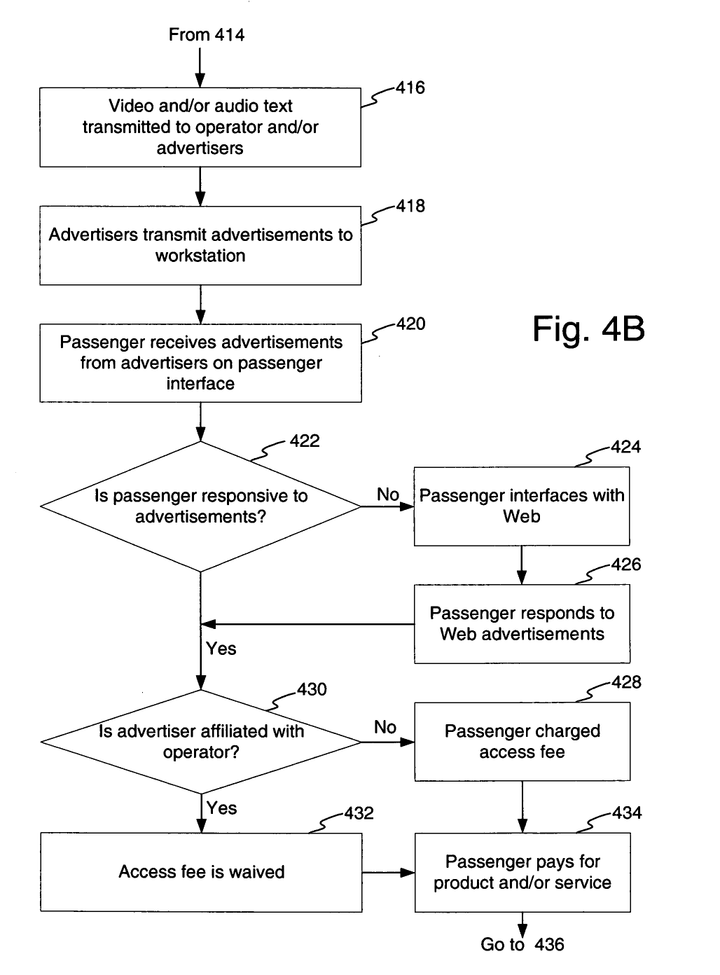

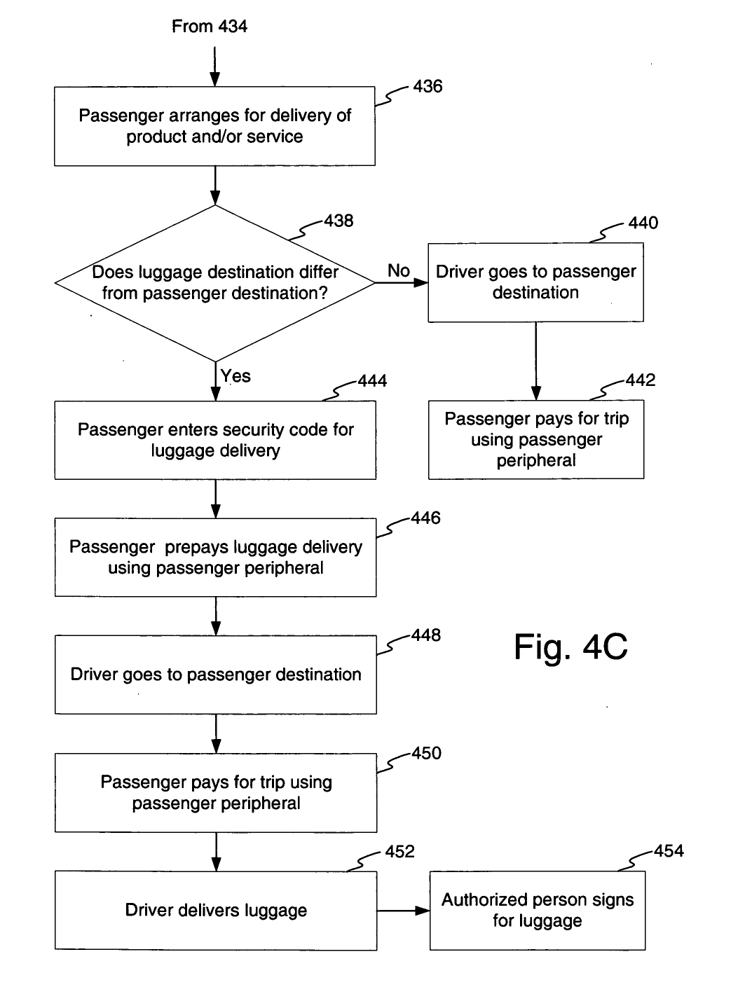

FIGS. 4A, B and C illustrate an operational flow diagram of an exemplary embodiment of a method of operation/implementation of a for-hire vehicle system. It will be appreciated that the method illustrated herein is but one example of numerous other possible implementations of the system.

Referring now to FIG. 4A, one or more passengers may flag down a for-hire vehicle. In step 400, one or more passengers may enter the for-hire vehicle. When a passenger enters the for-hire vehicle, in step 402 one or more sensors (not shown) located in a portion of the vehicle may activate one or more passenger interfaces of a workstation of the for-hire vehicle. The one or more sensors may be any type of sensor including optical, infra-red, electrical contact, pressure and the like, and combinations thereof.

When the workstation is activated, in step 404 video and/or monitoring of activities in the for-hire vehicle may begin. As described above, video and/or audio monitoring provide various security and advertising features to the communication system.

Furthermore, a driver of the for-hire vehicle may enter data supplied by the passenger using a driver interface coupled to a workstation (see FIG. 2 and description above) and transmit the data to one or more operators and/or one or more advertisers.

In step 406, a driver may suggest that each passenger access their workstation's passenger interface. It will be appreciated that each passenger may have a separate passenger interface or that there may be one passenger interface shared by several passengers. The driver may be motivated to make this suggestion by offering the driver another source of compensation as described above.

In step 408 the driver may query passengers about their luggage. In step 410 the driver may load passengers' luggage into a for-hire vehicle's secured location. A secured location may be a trunk of the vehicle or any other portion of the vehicle configured to receive the luggage (see FIG. 3 and description above).

Optionally, in step 412 if passengers have no luggage, they may access a workstation's passenger interface. In step 414 audio from passengers and the driver may be detected and converted and/or translated into text. The passenger interface may display initial information including instructions on how to use the passenger interface. If voice recognition software detects passengers speaking a non-native language, the information display may be in the passengers' language.

Referring now to FIG. 4B, in step 416 video and/or audio may be transmitted to one or more operators and/or one or more advertisers affiliated with operators. As discussed above, video may provide information to advertisers regarding specific passenger needs according to their attire (business wear, casual wear) or other characteristics (age, gender), associations (for example passengers may include children) and demeanor. Based on an analysis of video and/or audio, advertisers may select advertisements for presentation to passengers. According to step 418 advertisers may transmit advertisements to for-hire vehicles' workstations. Advertisements may be pre-loaded into each for-hire vehicle's workstation and selected for presentation to passengers by operators and/or advertisers. Optionally advertisements may be downloaded by operators and/or advertisers to each workstation for subsequent display to passengers. In step 420 passengers may receive advertisements from advertisers on their passenger interface.

In step 422 passengers may select whether to respond to advertisements supplied by advertisers. It is contemplated that responses may include selecting one or more offers for products and/or services or simply having an on-line conversation with advertisers to further determine details of the offers. In step 424 a passenger may refuse offers and decide to interface with the Web to access various types of information. For example, the passenger may wish to access e-mail, weather, available entertainment, history of locations being visited and the like, and combinations thereof.

In step 426 a passenger may respond to one or more Web (Internet) advertisements. Once again, the passenger may chat on-line with Web advertisers to determine details of any offers. If a passenger is responsive to any advertisements, in step 430 a component of the workstation's software may be configured to determine if advertisers selected by the passenger are affiliated with one or more operators. In step 428 a passenger may be charged a fee for accessing the workstation if none of the advertisers are affiliated with operators. Alternatively, in step 432 the access fee may be waived if one or more operators and advertisers are affiliated.

In step 434 a passenger may accept an offer of products and/or services. The passenger may pay for the products and/or services using any currency equivalent recognizable by a passenger peripheral (see FIG. 2 and description above).

Referring to FIG. 4C, on acceptance and payment of any offer, in step 436 a passenger may arrange for delivery of the selected products and/or services. A passenger may request delivery to a hotel, home address and the like. Alternatively, a passenger may request that the for-hire vehicle driver divert from an original destination to other destinations to permit the passenger to obtain the selected products and/or services.

In step 438 a driver may receive instructions from a passenger that the passenger's destination and luggage destination are different. If the passenger destination and luggage destination are different, in step 444 the passenger may enter a security code for secured luggage delivery using the passenger interface. The security code may also include passenger's luggage destination information and a total number of passenger's luggage to be delivered. In step 446, a passenger may pre-pay luggage delivery using a passenger peripheral (see FIG. 2 and description above) if the passenger desires to leave at a destination prior to luggage delivery. The passenger may receive a printed receipt of this transaction for subsequent verification of payment and luggage details.

In step 448, the driver goes to the passenger's destination and in step 450 the passenger may pay for the trip using the passenger's peripheral. The passenger may receive a printed receipt for this transaction. Subsequently, in step 452, the driver may deliver the passenger's luggage to the passenger's selected location. When the driver accesses the for-hire vehicle's secured location, a signal may be transmitted from a sensor located in the secured location to the workstation indicating that access has occurred (see FIG. 3 and description above). The driver may unload the luggage at the passenger's luggage destination to one or more persons at the destination who are authorized to receive the passenger's luggage. In an embodiment of the system, in step 454 the driver may request that the authorized person sign a driver's peripheral coupled to the driver interface to record when custody of the luggage was changed and who received the luggage.

Optionally, if a passenger has no luggage, in step 440 the driver goes to the passenger's destination and in step 442 the passenger may pay for the trip using the passenger's peripheral. The passenger may receive a printed receipt for this transaction.

Various other features, aspects and applications for the invention will be appreciated.

It will be appreciated that the definition of “for hire” vehicle may encompass more than just an automobile or similar vehicle, but may include busses, trains, a shuttle bus or even aircraft. It will also be appreciated that the invention is not limited to use by a “driver,” but a tour or shuttle bus attendant, airline or train attendant or other personnel.

As described above, a variety of “economic” models may be utilized to fund the operation of the system or generate income therefrom. As indicated, such may include revenue from advertisers. In one embodiment, a system operator may lease vehicle space and place the relevant equipment in the vehicle. In this scenario, the vehicle operator receives “rental” income. The operator may also receive addition benefit, such as information about the vehicle and/or driver (such as vehicle location, car diagnostic and other information) which is provided by the operator of the system. The system operator may receive income from advertisers and/or passenger transactions.

In one embodiment, the system may be utilized to take surveys, such as surveys of passengers. The system may also be utilized to provide additional information to passengers. For example, a passenger might provide their hotel name and room number and the system may be configured to obtain a receipt from the hotel and then disseminate it to the passenger (such as in the form of an SMS message or printed receipt).

While various embodiments of the invention have been described, it will be apparent to those of ordinary skill in the art that many more embodiments and implementations are possible that are within the scope of this invention.

1. An interactive for-hire vehicle communication system comprising, in combination:
at least one audio device located in a for-hire vehicle;
a workstation in communication with said at least one audio device, and said workstation in communication with at least one passenger interface located in said for-hire vehicle;
at least one of said workstation and at least one server configured to receive passenger audio information received by said audio device and convert said passenger audio information to text suitable for passenger-related interactive information exchange to at least one passenger interface of said for-hire vehicle.

2. The system according to claim 1 further comprising at least one video device in communication with said workstation, said at least one video device configured to receive image information suitable for transmission to said at least one server to provide interactive information exchange to at least one passenger interface of said for-hire vehicle.

3. The system according to claim 2 wherein said audio information and said image information are accessible by at least one agency to provide enhanced security in said for-hire vehicle.

4. The system according to claim 1 further comprising a driver interface coupled to said workstation, said driver interface configured to input passenger data to said workstation and transmit said passenger data to said at least one server.

5. The system according to claim 1 further comprising at least one sensor coupled to said workstation, said sensor configured to monitor a portion of said for-hire vehicle.

6. The system according to claim 1 further comprising at least one communication exchange device coupled to said workstation, said at least one communication device configured to communicate with at least one of a carrier network, an Internet network, an intranet network and another for-hire vehicle.

7. The system according to claim 1 wherein said at least one passenger interface facilitates at least one transaction after interactive exchange of passenger-related information received and selected by at least one passenger of said for-hire vehicle.

8. A method of communicating selectable passenger-related information to a for-hire vehicle, comprising the steps of:
receiving at least one of audio information and video information by a workstation located in a for-hire vehicle;
transmitting said at least one of audio information and video information to at least one server in communication with said workstation;
converting at least a portion of said audio information to text by at least one of said workstation and said at least one server;
generating passenger-related input at a driver interface coupled to said workstation;
receiving said passenger-related input by at least one of said workstation and said at least one server; and
communicating interactively with at least one passenger interface of said for-hire vehicle to provide selectable passenger-related information based on at least one of said text, said video information and said driver generated passenger-related input.

9. The method of claim 8 further comprising the steps of:
filtering background noise from a selected portion of said audio information;
amplifying a selected portion of said audio information;
selecting passenger-related information to communicate to said workstation; and
communicating said passenger-related information from said workstation to said at least one passenger interface.

10. The method of claim 8 further comprising the step of:
accessing at least one of said audio information and said image information from at least one of said workstation and said at least one server if requested during an emergency situation in said for-hire vehicle.

11. The method of claim 8 further comprising the step of:
accessing at least one of said audio information and said image information from at least one of said workstation and said at least one server if requested to locate passenger belongings left in said for-hire vehicle.

12. The method of claim 8 further comprising the steps of:
charging a fee to access said at least one passenger interface;
selecting at least one payer of said fee; and
receiving revenue from said at least one payer.

13. The method of claim 8 further comprising the steps of:
receiving internet information including at least one offer of at least one of a product and a service at said at least one passenger interface;
selecting said at least one offer at said at least one passenger interface;
accepting payment for said offer at said at least one passenger interface;
receiving receipt information for payment for said offer at said at least one passenger interface; and
accepting payment at said at least one passenger interface for travel in said for-hire vehicle.

14. The method of claim 8 further comprising the steps of:
coupling a distance meter to at least one of said driver interface and said workstation to indicate distance traveled; and
communicating to said driver interface when passenger payment is received at said at least one passenger interface.

15. The method of claim 8 further comprising the step of:
communicating local traffic condition information from a for-hire vehicle to at least one other for-hire vehicle to both receive and transmit passenger pickup opportunities and to optimize travel routing.

16. The method according to claim 8 further comprising the steps of:
securing belongings of at least one passenger deposited in a portion of said for hire-vehicle;
entering a security code on said at least one passenger interface indicating date and time of securing said belongings;
receiving payment for delivery of said belongings to at least one selected location;
receiving receipt data for said payment and said security code associated with said belongings;
delivering said belongings to said selected at least one location after departure of said at least one passenger from said for-hire vehicle; and
receiving an authorization at said driver interface to indicate when said belongings were delivered at said at least one location.
